(19) United States
(12) Patent Application Publication
(10) Pub. No.: US 2025/0128593 A1
(43) Pub. Date: Apr. 24, 2025

(54) SNAP CONNECTION, MOTOR VEHICLE STRUCTURE AND MOTOR VEHICLE

(71) Applicant: Vibracoustic SE, Darmstadt (DE)

(72) Inventors: Rolf Bröker, Freiburg (DE); Markus Kist, Bantzenheim (DE); Christian Paul, Auggen (DE); Joschka Gutmann, Staufen Im Breisgau (DE)

(21) Appl. No.: 18/906,382

(22) Filed: Oct. 4, 2024

(30) Foreign Application Priority Data
Oct. 5, 2023 (DE) 10 2023 127 187.3

(51) Int. Cl. B60K 11/04

(52) U.S. Cl. CPC B60K 11/04

(57) ABSTRACT

A snap-action connection of an assembly mount of a motor vehicle includes an elastomer connector and a latching stud. In embodiments, the elastomer connector has, on an outer side, at least one first groove, provided for fixing on a holding structure, the elastomer connector has a cavity or through-aperture, the cavity or through-aperture has at least one first latching contour, the latching stud has at least one second latching contour, the latching stud can be inserted into the cavity or through-aperture in a direction of insertion and can be snapped in through the interaction of the at least one first latching contour and at least one second latching contour, and the elastomer connector has a compression geometry configured, in the event of tension on the latching stud, to compress counter to the direction of insertion and stiffen the connector in the region of the at least one first latching contour.

### CROSS-REFERENCE TO RELATED APPLICATIONS

This application claims priority to German Patent Application No. DE 10 2023 127 187.3, filed on Oct. 5, 2023, the contents of which is hereby incorporated by reference in its entirety.

### TECHNICAL FIELD

The invention relates to a snap-action connection, a motor vehicle structure, and a motor vehicle.

### BACKGROUND

Snap-action connections, motor vehicle structures, and motor vehicles of the type stated at the outset are widely known. Corresponding snap-action connections have several functions. On the one hand, they must allow rapid installation of assemblies and components, preferably without excessively high assembly forces, often for manual installation by mechanics. On the other hand, however, they should reliably hold under the usual forces that act on them.

U.S. Pat. No. 11,255,362 B2 discloses a mount assembly comprising a core, an elastomer element connected to the core, and a clip connected to the elastomer element. In embodiments, the clip can be configured in such a way that it connects the mount assembly to a mating component. Embodiments of a clip may comprise a plurality of support elements and a plurality of clip portions. A clip for a mount assembly may include a flange, a base, a plurality of support elements extending in an axial direction between the flange and the base, and a plurality of clip portions extending from the base towards and short of the flange.

The disadvantage of this is that the connection formed is a latching connection with a large number of clips, making removal laborious.

On the other hand, corresponding snap-action connections should be easy to release for maintenance and repair work, preferably without tools, and this represents a certain conflict of aims with reliable retention.

Another known object of such snap-action connections is vibration isolation, particularly in order to optimize NVH behaviour. Snap-action connections comprising elastomeric materials are therefore known.

### SUMMARY

An object of the present disclosure is to overcome known challenges or disadvantages of the prior art, and to specify a snap-action connection, a motor vehicle structure and/or a motor vehicle that may combine easy fitting and removal with reliable retention and, at the same time, may provide good NVH behaviour.

Such challenges may be addressed by a snap-action connection, a motor vehicle structure, and a motor vehicle according to aspects and teachings of the disclosure.

A description is given of a snap-action connection of an assembly mount of a motor vehicle, comprising an elastomer connector and a latching stud, wherein the elastomer connector has, on an outer side, at least one first groove, which is provided for fixing on a holding structure, wherein the elastomer connector has a cavity or through-aperture, wherein the cavity or through-aperture has at least one first latching contour, wherein the latching stud has at least one second latching contour, wherein the latching stud can be inserted into the cavity or through-aperture in a direction of insertion and can be snapped in through the interaction of the at least one first latching contour and at least one second latching contour, wherein the elastomer connector has a compression geometry which is configured, in the event of tension on the latching stud, to compress counter to the direction of insertion and thereby harden the elastomer connector in the region of the at least one first latching contour.

The elastomer connector can be of cup-type or tubular configuration, wherein various outer contours are possible, from round to polygonal and even free forms, depending on the respective use. The choice of the appropriate geometry and configuration depends on the respective planned use.

The elastomer can consist of natural rubber, synthetic rubber, PE, PU, silicone or other materials. The elastomer can contain various additives to adjust the material properties of the elastomer, e.g. hardness, temperature stability, abrasion resistance, surface roughness and the like.

The elastomer provides vibration damping, improving the NVH behaviour of a correspondingly equipped motor vehicle.

The latching stud has a higher stiffness than the elastomer connector. Inter alia, the latching stud can consist of plastic or metal. The latching stud can be an integral part of a body or of a component or of an assembly. For assembly, the latching stud is inserted into the cavity or through-aperture. The latching stud has a geometry which enables insertion into the cavity or through-aperture and allows secure retention with correct seating of the latching stud relative to the elastomer connector.

When an appropriate force is applied counter to the direction of insertion, the compression geometry is compressed and thereby locks the latching stud in the elastomer connector up to forces higher than the forces required for assembly. By means of the compression geometry, it is thus possible to ensure that a required force to release the snap-action connection counter to the direction of insertion is significantly higher than a required force to close the snap-action connection in the direction of insertion. In this way, simplicity of assembly can be combined with secure retention.

A first further development stipulates that the elastomer connector has a contact surface, wherein the latching stud has a collar, wherein the collar comes into contact with the contact surface, at least when the latching stud is subjected to an axial load in the direction of insertion.

The contact surface can project into the cavity or through-aperture. The contact surface and the collar can be partly aligned parallel to one another in order to ensure surface contact between the collar and the contact surface and, as a result, better force transmission with, at the same time, lower loading of the components per unit area.

Another further development stipulates that the at least one first latching contour has at least one latching projection and/or latching collar and/or latching groove, wherein the at least one second latching contour has at least one substantially complementary latching projection and/or latching collar and/or latching groove.

In this way, it is possible to achieve surface contact between the first latching contour and the second latching contour.

Another further development stipulates that the first latching contour and the second latching contour have bevels on a side oriented towards the direction of insertion and/or on a side facing away from the direction of insertion, thus enabling the latching between the elastomer connector and the latching stud to be established and released.

The bevels can reduce the required insertion forces in the direction of insertion.

Counter to the direction of insertion, the bevels make it possible to avoid locking of the latching stud in the elastomer connector. Locking could cause destruction of the latching stud and/or elastomer connector during the attempt to release the latching connection and could possibly entail additional damage.

Another further development stipulates that the first latching contour is arranged further forwards in the direction of insertion than the first groove, wherein the compression geometry is arranged axially between the first latching contour and the first groove or at the level of the first latching contour.

In this case, a contact surface of the elastomer connector is arranged axially further forwards than the compression geometry. This ensures that forces counter to the direction of insertion that are introduced via the latching stud are transmitted via the relevant contact surface of the elastomer connector from a mating contact surface of the latching stud to the first latching contour of the elastomer connector. These forces are in the direction of the first groove of the elastomer connector and are transmitted via the compression geometry. As a consequence, this leads to deformation and compression or even a collapse of the compression geometry, bringing about an accumulation of material of the elastomer connector above the second latching contour of the latching stud, with the result that the holding forces of the elastomer connector counter to the direction of insertion rise and the latching stud is securely held.

Another further development stipulates that the elastomer connector has, on the outer side, a gripping region arranged further forwards in the direction of insertion, wherein, in order to remove the latching stud, compression of the compression geometry can be prevented by pulling on the gripping region in the direction of insertion.

Pulling on the gripping region in the direction of insertion makes it possible to prevent compression or a collapse of the compression geometry, and the latching contour can be removed with significantly lower forces than without pulling on the gripping region, thereby enabling easy removal.

Another further development stipulates that the gripping region has at least one holding bead or gripping geometry or friction-increasing structure.

This makes removal easier.

Another further development stipulates that the latching stud has a step contour.

A step contour makes it easier to fit and remove the latching stud in comparison with an embodiment without a step.

Another further development stipulates that the latching stud consists of plastic or metal, in particular aluminium.

Another further development stipulates that the compression geometry is a compression groove.

The compression groove can be filled with an easily compressible material or can be unfilled. Such a groove can easily be provided during the production of the elastomer connector.

A first independent subject relates to a motor vehicle structure comprising an assembly fixed on a motor vehicle by means of at least one snap-action connection of the abovementioned type.

A first further development stipulates that at least one latching stud is arranged on the assembly, wherein at least one elastomer connector is arranged on a motor vehicle body.

Another further development stipulates that the at least one latching stud is arranged movably on the assembly.

Another further development stipulates that at least one holding bracket having a receiving groove and/or receiving recess for receiving the at least one elastomer connector is provided on the motor vehicle body.

In one embodiment, the holding bracket can be a separate component from the elastomer connector while, in another embodiment, it can be connected to the elastomer connector.

Another independent subject relates to a motor vehicle comprising at least one motor vehicle structure of the abovementioned type.

### BRIEF DESCRIPTION OF THE DRAWINGS

Further features, details and advantages of the invention will become apparent from the wording of the claims and from the following description of exemplary embodiments with reference to the drawings. In the drawings:

FIG. 1 shows a perspective view of a motor vehicle structure comprising an engine radiator, which is fixed on a body of a motor vehicle by means of two snap-action connections;

FIG. 2 shows a front view of the motor vehicle structure from FIG. 1;

FIG. 3 shows an enlarged detail from FIG. 2;

FIG. 4 shows a front sectioned view of the motor vehicle structure from FIG. 1;

FIG. 5 shows an enlarged detail from FIG. 4; and

FIGS. 6A through 6E show various phases of the insertion, locking and removal of a latching stud of the snap-action connection.

### DETAILED DESCRIPTION

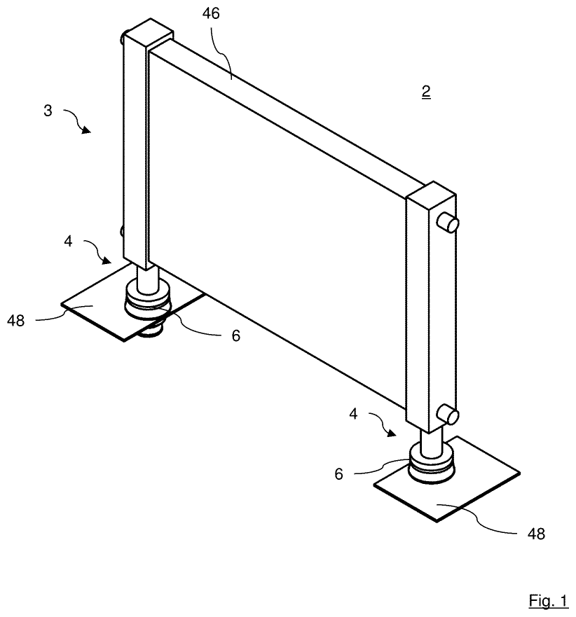

FIG. 1 shows a perspective view of a motor vehicle 2 comprising a motor vehicle structure 3 with an engine radiator 46 fixed on an assembly mount 4 by means of two snap-action connections 6. The assembly mounts 4 are attached to a body 48 of the motor vehicle 2.

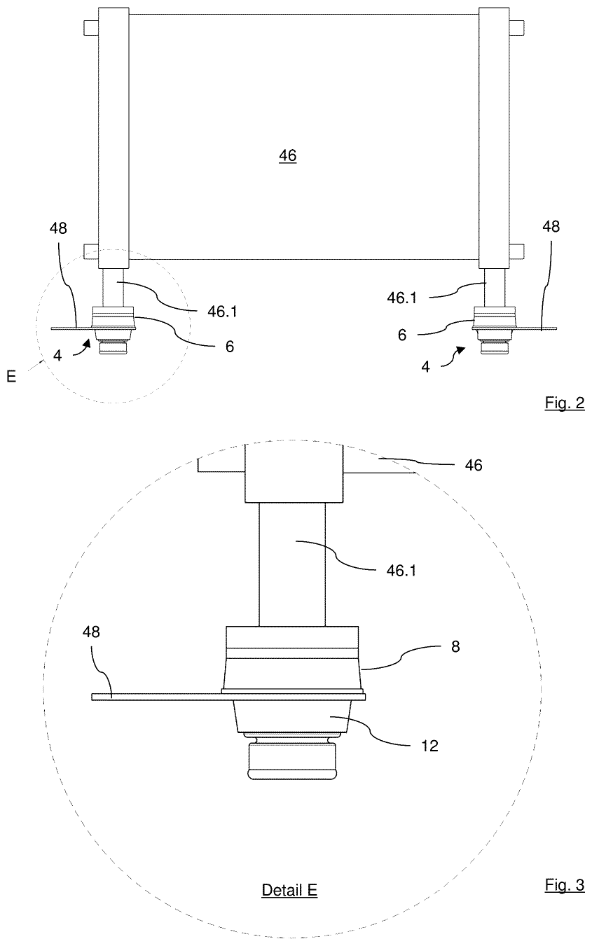

FIG. 2 shows a front view of the assembly from FIG. 1.

The two snap-action connections 6 are arranged at the same level. The engine radiator 46 has two upright tubes 46.1, at the ends of which a latching stud (not visible in FIG. 2) of the snap-action connections 6 is arranged, said stud being fixed on the radiator.

FIG. 3 shows an enlarged detail from FIG. 2.

The snap-action connection 6 has an elastomer connector 8, which is fixed on the body 48 and in which the latching stud (not visible in FIG. 3) of the engine radiator 46 engages.

The elastomer connector 8 consists of vulcanized natural rubber.

The elastomer connector 8 is rotationally symmetrical.

A holding bracket 12, in which the elastomer connector 8 of the assembly mount 4 is received, is arranged in a corresponding cutout in the body 48. The holding bracket 12 consists of a plastic that is harder and more abrasion-resistant than the elastomer connector 8. The holding bracket 12 thus protects the elastomer connector 8 from damage by the body 48, which consists of metal. Without a holding bracket 12, there would be the risk of damage to the elastomer connector 8 due to an edge of the body 48 cutting into the elastomer connector 8.

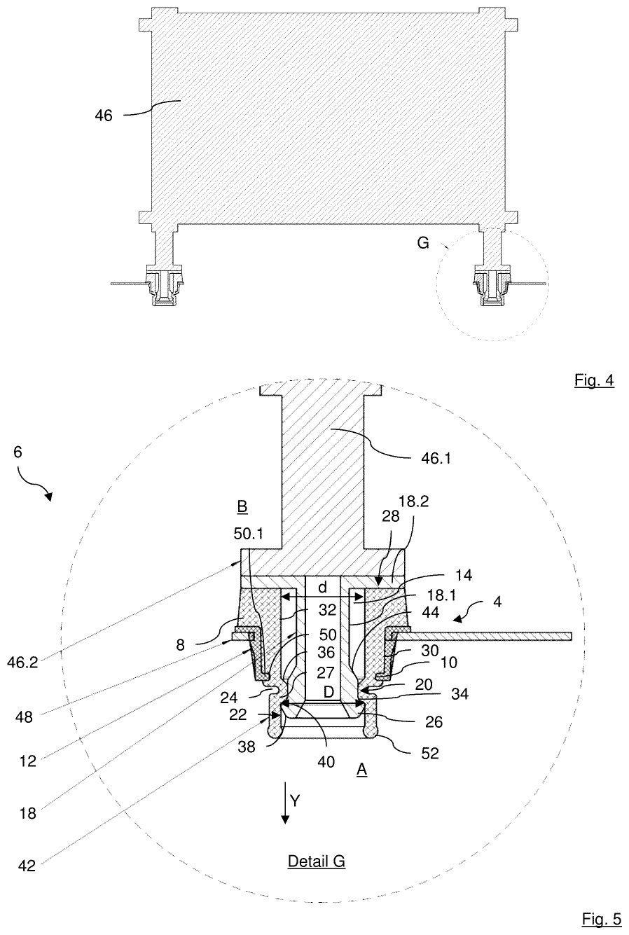

FIG. 4 shows a front sectioned view of the motor vehicle structure 3.

FIG. 5 shows an enlarged detail G from FIG. 4.

The holding bracket 12 has a receiving recess 50, in which the elastomer connector 8 of the assembly mount 4 is received and in which the elastomer connector 8 rests in partial surface contact by means of an outer side 30. For this purpose, the receiving recess 50 has a collar 50.1, which projects inwards and which engages in a first groove 10 of the elastomer connector 8. The first groove 10 is arranged on the outer side 30 of the elastomer connector 8 and is of encircling design.

The elastomer connector 8 has a through-aperture 14, in which a first latching contour 20 is formed. The first latching contour 20 is formed on a latching collar 27, which projects as an encircling bead into the through-aperture 14. The latching collar 27 has a bevel 36, which is oriented towards a side B facing away from the direction of insertion Y, and a bevel 40, which is oriented towards a side A facing in the direction of insertion Y. The bevels 36, 40 serve to ensure non-destructive fitting and removal of the latching stud 18 on the elastomer connector 8.

An upright tube collar 46.2 is formed on the upright tube 46.1 of the engine radiator 46.

A disk-type collar 18.2 is formed on the latching stud 18 on the opposite side of the latching stud 18 from the collar 26. The collar 18.2 is bonded to the upright tube collar 46.2. In other embodiments, the latching stud can be formed integrally with the upright tube 46 or can be secured in some other way, e.g. being screwed or welded.

The latching stud 18 has a second latching contour 22, which is formed on a collar 26. The collar 26 has a larger maximum diameter than a shank 18.1 of the latching stud 18. The collar 26 has a bevel 34, which is oriented towards a side B facing away from the direction of insertion Y, and a bevel 38, which is oriented towards a side A facing in the direction of insertion Y. The bevels 34, 38 serve to ensure non-destructive fitting and removal of the latching stud 18 on the elastomer body 8.

In the region in front of the collar 26 in the direction of insertion Y, i.e. towards side B, the latching stud 18 has a material-thickening step contour 44 to allow the transmission of higher forces.

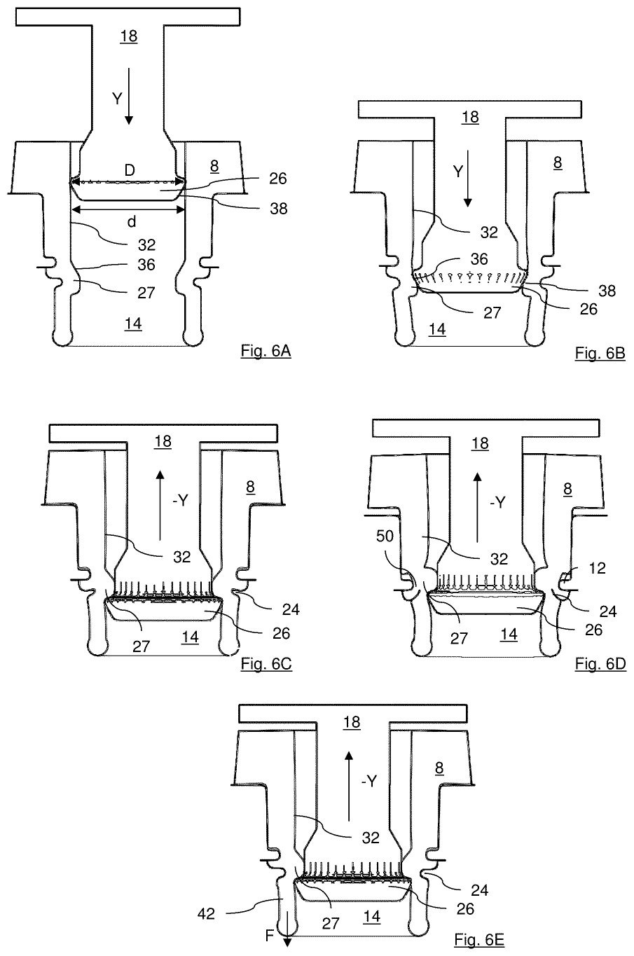

As illustrated in FIGS. 6A and 6B, the latching stud 18 is inserted into the through-aperture 14 in a direction of insertion Y. Above the first latching contour 20 in the direction of insertion Y, an inner side 32 of the elastomer connector 8 has a clear width d which corresponds substantially to a maximum diameter D of the second latching contour 22 of the latching stud 18. The clear width d can be in the range of from 0 to 2 mm less than or in the range of from 0 to 4 mm greater than or equal to the maximum diameter D of the second latching contour 22. This allows low-friction insertion of the latching stud into the through-aperture 14.

During the insertion of the latching stud 18 into the elastomer connector 8, the bevel 36 on the first latching contour 20 of the elastomer connector 8 and the corresponding bevel 38 of the latching stud 18 facilitate temporary widening of the latching collar 27 of the elastomer connector 8 and pushing of the collar 26 of the latching stud 18 past the latching collar 27 of the elastomer connector 8.

As soon as the second latching contour 22 of the latching stud 18 has passed the first latching contour 20 of the elastomer connector 8 axially in the direction of insertion Y, the material of the elastomer connector 8 can relax again and forms a positive fit with the latching stud 18, and the latching stud 18 has snapped in.

Vibration is damped by the elastic properties of the elastomer connector 8, and this largely suppresses transmission of structure-borne noise from the engine radiator 46 to the body 48 and vice versa and thus prevents noise propagation in the motor vehicle 2.

The elastomer connector 8 has a contact surface 28, against which the latching stud 18 rests in surface contact by means of the collar 18.2 arranged on the shank 18.1. This increases the stability of the snap-action connection 6 and allows force transmission over a wider area between the engine radiator 46 and the assembly mount 4.

Also arranged on the outer side 30 of the elastomer connector 8 is an encircling compression groove 24, which is situated substantially at the level of the first latching contour 20 when considered in the direction of insertion Y, wherein a bevel 34 of the elastomer connector 8 rests against a bevel 40 of the latching stud 18 in the latched state illustrated and is further forwards than the compression groove 24 when considered in the direction of insertion Y. In the event of tension on the latching stud 18 counter to the direction of insertion Y, this being transmitted from the engine radiator 46 and the upright tube 46.1, for example, on account of dynamic forces during the trip, these forces act on the compression groove 24, which, as a result, initially collapses partially and, in the case of higher forces, completely. This causes an additional accumulation of material in the region of the collar 50.1 of the receiving recess 50 of the holding bracket 12, as a result of which the resistance counter to the direction of insertion Y rises considerably, and unlatching of the latching stud 18 is made correspondingly more difficult. At the same time, a small axial amplitude is allowed, this being damped by the elastomer connector 8, which furthermore contributes to noise reduction.

On the outer side 30, the elastomer connector 8 has a gripping region 42, which is arranged further forwards in the direction of insertion Y and on the front end of which a holding bead 52 is formed. To remove the engine radiator 46, the elastomer connector 8 is gripped in the gripping region, and tension is exerted in the direction of insertion Y. As illustrated in FIG. 6E, it is thereby possible to prevent compression of the compression groove 24, and the collar 26 of the latching stud 18 can slide past the latching collar 27 of the elastomer connector 8 by means of the corresponding bevels 34, 40.

FIGS. 6A to 6E show various states of the snap-action connection 6.

FIGS. 6A and 6B each illustrate fitting of the latching stud 18. In FIG. 6A, the latching stud 18 is inserted into the through-aperture 14 in the direction of insertion Y and slides along the inner side 32 of the elastomer connector 8.

When the collar 26 of the latching stud 18 meets the latching collar 27 of the elastomer connector 8, as illustrated in FIG. 6B, the latching collar 27 of the elastomer connector 8 is spread apart by the interaction of the bevels 36, 38 on the elastomer connector 8 and the latching collar 18 and allows the collar 26 of the latching stud 18 to pass and thus to snap in. The snapped-in state is illustrated in FIG. 5.

FIGS. 6C and 6D show a state of loading with a motion component counter to the direction of insertion Y. On account of the forces transmitted from the latching stud 18 to the elastomer connector 8 during this process, the compression groove 24 initially collapses partially (FIG. 6C) and subsequently completely (FIG. 6D), as a result of which the latching collar 27 of the elastomer connector 8 thickens into a thick bead which is situated in front of the collar 26 of the latching stud 18 and prevents the latching stud 18 from slipping out since it blocks the receiving recess 50 of the holding bracket 12.

FIG. 6E shows that, when the intention is to remove the latching stud 18, it is possible to pull on the gripping region 42 of the elastomer connector 8 with a holding force F in the direction of insertion Y in order to prevent collapse of the compression groove 24, thereby enabling the collar 26 of the latching stud 18 to be guided past the latching collar 27 of the elastomer connector 8.

The invention is not limited to one of the embodiments described above but can be modified in many different ways.

All of the features and advantages, including design details, spatial arrangements and method steps, that are disclosed by the claims, the description and the drawing may be essential to the invention, either in themselves or in a very wide variety of combinations.

1. A snap-action connection of an assembly mount of a motor vehicle, comprising:
an elastomer connector; and
a latching stud,
wherein the elastomer connector has, on an outer side, at least one first groove, which is provided for fixing on a holding structure, wherein the elastomer connector has a cavity or through-aperture, wherein the cavity or through-aperture has at least one first latching contour, wherein the latching stud has at least one second latching contour, wherein the latching stud is adapted for insertion into the cavity or through-aperture in a direction of insertion and can be snapped in through an interaction of the at least one first latching contour and at least one second latching contour, wherein the elastomer connector has a compression geometry which is configured, in the event of tension on the latching stud, to compress counter to the direction of insertion and thereby stiffen the elastomer connector in a region of the at least one first latching contour.

2. The snap-action connection according to claim 1, wherein the elastomer connector has a contact surface, wherein the latching stud has a collar, and wherein the collar comes into contact with the contact surface, at least when the latching stud is subjected to an axial load in the direction of insertion.

3. The snap-action connection according to claim 1, wherein the at least one first latching contour has at least one latching projection and/or latching collar and/or latching groove, and wherein the at least one second latching contour has at least one substantially complementary latching projection and/or latching collar and/or latching groove.

4. The snap-action connection according to claim 3, wherein the first latching contour and the second latching contour have bevels on a side oriented towards a direction of insertion and/or on a side facing away from the direction of insertion, enabling the latching between the elastomer connector and the latching stud to be established and released.

5. The snap-action connection according to claim 1, wherein the first latching contour is arranged further forwards in the direction of insertion than the first groove, and wherein the compression geometry is arranged axially between the first latching contour and the first groove or at a level of the first latching contour.

6. The snap-action connection according to claim 1, wherein the elastomer connector has, on the outer side, a gripping region arranged further forwards in the direction of insertion, and wherein, in order to remove the latching stud, compression of the compression geometry can be prevented by pulling on the gripping region in the direction of insertion.

7. The snap-action connection according to claim 6, wherein the gripping region has at least one holding bead or gripping geometry or friction-increasing structure.

8. The snap-action connection according to claim 1, wherein the latching stud has a step contour.

9. The snap-action connection according to claim 1, wherein the latching stud consists of plastic or metal.

10. The snap-action connection according to claim 1, wherein the compression geometry is a compression groove.

11. A motor vehicle structure comprising an assembly fixed on a motor vehicle by means of at least one snap-action connection according to claim 1.

12. The motor vehicle structure according to claim 11, wherein at least one latching stud is arranged on the assembly, and wherein at least one elastomer connector is arranged on a motor vehicle body.

13. The motor vehicle structure according to claim 12, wherein the at least one latching stud is arranged movably on the assembly.

14. The motor vehicle structure according to claim 12, wherein at least one holding bracket having a receiving groove and/or receiving recess for receiving the at least one elastomer connector is provided on the motor vehicle body.

15. The motor vehicle comprising at least one motor vehicle structure according to claim 11.

16. The snap-action connection according to claim 1, wherein the latching stud consists of aluminium.
